(19) United States
(12) Patent Application Publication
(10) Pub. No.: US 2007/0247112 A1
(43) Pub. Date: Oct. 25, 2007

(54) Assembled Lithium-ion Battery Pack with Large Capacity

(75) Inventors: Jiangsu Yu, Nanjing (CN); Weiguang Xiao, Nanjing (CN); Yelin Chen, Nanjing (CN)

Correspondence Address: GLOBAL IP SERVICES, 2462 ROCK ST., APT. 6, MOUNTAIN VIEW, CA, 94043, US

(73) Assignee: SWIT ELECTRONIC CO., LTD., Nanjing (CN)

(21) Appl. No.: 11/460,974

(22) Filed: Jul. 29, 2006

(30) Foreign Application Priority Data
Apr. 18, 2006 (CN) 200610039641.3

(51) Int. Cl. H02J 7/00

(52) U.S. Cl. 320/112

(57) ABSTRACT

The present invention aims to solve the inconvenience in carrying assembled lithium-ion battery packs with large capacity to embark of the aviation apparatus. An assembled lithium-ion battery pack with large capacity comprises at least two boxes which can be connected as a single unit or disassembled as multiple boxes; each said box including multiple lithium-ion batteries connected in series or parallel, its total lithium equivalent is smaller than transportation safety bar; the multiple boxes being connected in series of parallel; one of said multiple boxes including an identification chip and alarm device controlled by said identification chip; other multiple boxes including an identity mark chip; said identification chip storing the identity mark of said identity mark chip. The present invention resolves successfully the safety problem for carrying the assembled lithium-ion battery pack with large lithium equivalent to embark of the aviation apparatus, and also resolves successfully the consistency problem for re-assembling the disassembled lithium batteries.

### CROSS REFERENCE TO THE RELATED PATENT APPLICATION

This patent application claims the priority of the Chinese patent application No. 200610039641.3, filed on Apr. 18, 2006.

### FIELD OF THE INVENTION

This invention involves the lithium-ion batteries. Especially, involves an assembled lithium-ion battery pack with large capacity that its lithium equivalent exceeds the transport safe bar (general for 8 gram lithium equivalent). Particularly, the present invention is a method and product relating to disassemble the assembled lithium-ion battery pack with large lithium equivalent into several lithium-ion batteries with small lithium equivalent under the transport safety bar for convenient carriage, and to assemble the disassembled batteries with small lithium as a assembled lithium-ion battery pack with large lithium equivalent when usage for advantages of assembled lithium-ion battery pack. Further more, the present invention provides a solution of matching the disassembled lithium batteries when reassembly.

### BACKGROUND OF THE INVENTION

Because lithium-ion batteries have advantages of lightweight and large capacity, the television camera and moveable electronic equipments all use it as a direct power supply. However, along with the aerial transport safety requirement becomes more serious, the single mass of assembled lithium-ion battery pack, its capacity is over 8 gram lithium equivalent, becomes dangerous goods, passenger can not bring it into airplane. This safety rule brings users particularly the news reporter lots of limitations and inconveniences. Because of the restriction of 8 gram lithium equivalent, people taking airplane must consign lithium-ion batteries having large lithium equivalent as dangerous goods with expensive fee. Otherwise, people must carry many small capacity lithium-ion batteries having short working life. It causes electronic equipments to replace batteries frequently. Thereby, the working efficiency is affected seriously. Some people connect two small capacity lithium-ion batteries in parallel to exalt capacity without considering the match requirements, such as battery's capacities, inner resistances, out port voltages, usage time and old degrees. However, this kind of simple merge can result in hurting batteries or hidden troubles in safety.

### SUMMARY OF THE INVENTION

The purpose of the present invention is to solve the inconvenience in carrying of lithium-ion batteries pack with large lithium equivalent to embark of the aviation apparatus; to provide an assembled lithium-ion battery pack with large capacity, which can be disassembled into multiple small ones for convenient carriage, can be assembled as single mass for functional work and can be identified for its battery's identity.

The Technical Scheme of this Invention is:

A kind of assembled lithium-ion battery pack with large capacity at least comprises two boxes, which are movably fixed with each other; each box has multiple lithium-ion batteries connected in series or parallel, their total lithium equivalent is below the transport safety bar; the part of connected lithium-ion batteries of one box is connected with other part of connected lithium-ion batteries of other box in series or parallel; one box has an identification chip, as well as an alarm device and an power switch controlled by the identification chip, other box have an identity mark chip, the identification chip stores the identity mark of the identity mark chip.

The boxes are fixed together by mechanical connecting structures, which can be a kind of dovetail join structure, plus a pin and hole locking structure.

The identity mark chip can be an electronic label. The identification chip stores the contents of the electronic label.

The identification chip connects an electronic switch formed by transistors of Q1 and Q2 for cutting power supply to electronic equipments automatically when the connected battery boxes do not match each other.

The alarm device is a buzzer or irradiance diode.

### The Valuable Results of the Present Invention:

1. The invention uses at least two pieces of lithium-ion batteries, which can be assembled as an assembled lithium-ion battery pack to provide strong electric power, which can be disassembled as two or more pieces of small lithium-ion battery pack to reduce the capacity of each small lithium-ion battery pack under the safety bar, therefore people can take them to embark an airplane safely and expediently.

2. The disassembled lithium battery pack of the present invention has intelligence control circuit for identifying the identity of each disassembled lithium-ion battery pack. Whether many disassembled lithium battery packs are put and mixed together, the intelligence control circuit can still identify them if the battery packs are matched for forming couples. If unqualified the alarm device will sound or flash to report the carrier or police, at the same time the circuit will cut off the power export circuit to prevent the mix usage of lithium-ion battery pack which are not matched (have different voltages, capacities or usage times to insure a safety).

3. The structure is simple, safe, practical and trusted.

### BRIEF DESCRIPTION OF THE DRAWINGS

FIG. 1 is a sketch drawing showing a perspective view of the assembled lithium-ion battery pack of the present invention.

FIG. 2 is a sketch drawing showing the connection of the lithium-ion batteries in a box of the present invention.

FIG. 3 is a sketch drawing showing the structure of one box of the present invention.

FIG. 4 is a cross section perspective drawing showing the partial structure of the box shown on the FIG. 3.

FIG. 5 is a sketch drawing showing the structure of another box of the present invention.

FIG. 6 is a cross section perspective drawing showing the partial structure of the box shown in the FIG. 5.

FIG. 7 is a diagram drawing showing the electricity principle of the present invention.

FIG. 8 is an electricity circle drawing for the present invention.

### DETAILED DESCRIPTION OF THE INVENTION

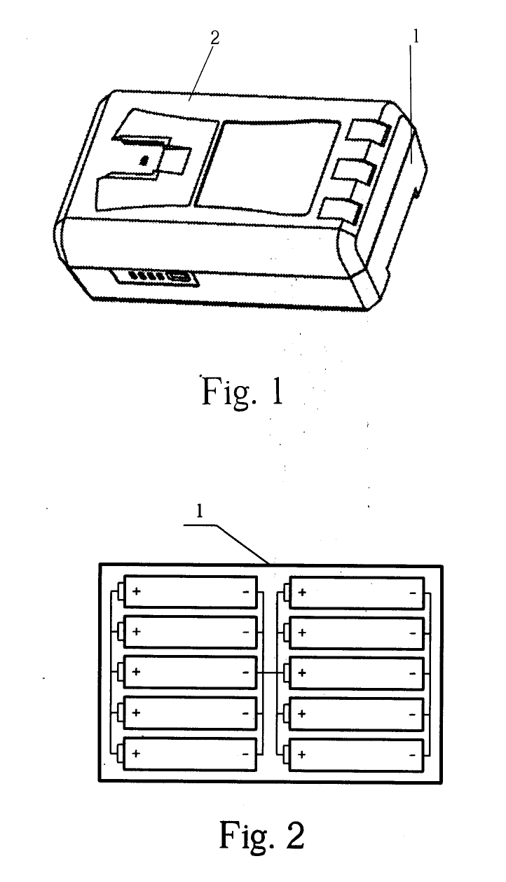

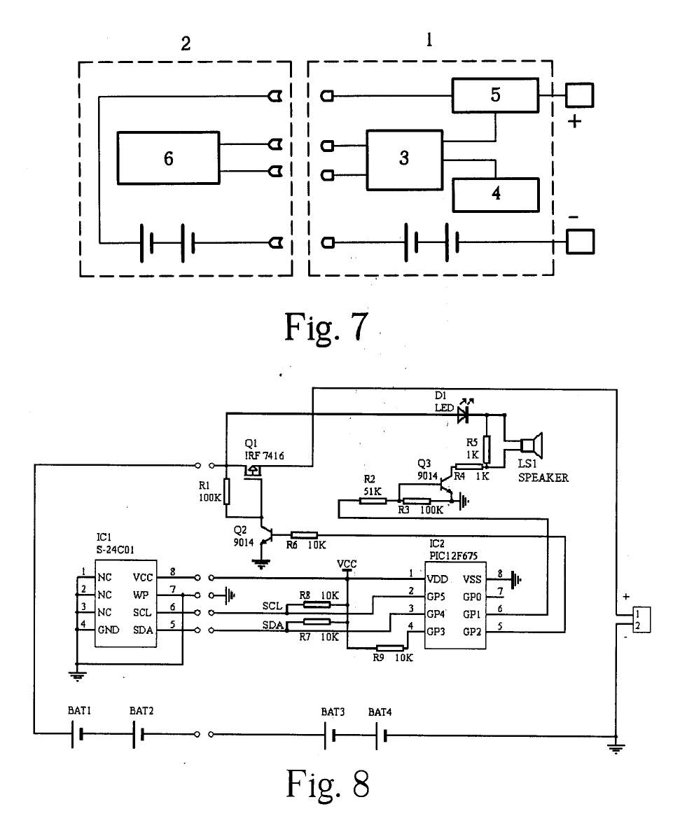

An assembled lithium-ion battery pack with large capacity having 8-16 gram lithium equivalent includes two boxes 1 and 2 that can be connected together. Refer to FIG. 1, the lithium-ion batteries in the boxes 1 and 2 are connected in series or parallel, the total value of lithium equivalent of the box 1 or 2 is smaller than the safety bar for transportation (8 gram lithium equivalents). Refer to FIG. 2, the lithium-ion battery pack in the box 1 are connected with the lithium-ion battery pack in the box 2 in series (or in parallel according to the requirement). Refer to FIG. 7, there are an identification chip 3 as well as an alarm device 4 and a power switch 5 controlled by the identification chip 3 in the box 1 or 2. There are identity mark chip in another box 2 or 1, the identification chip stores the identity mark of the identity chip.

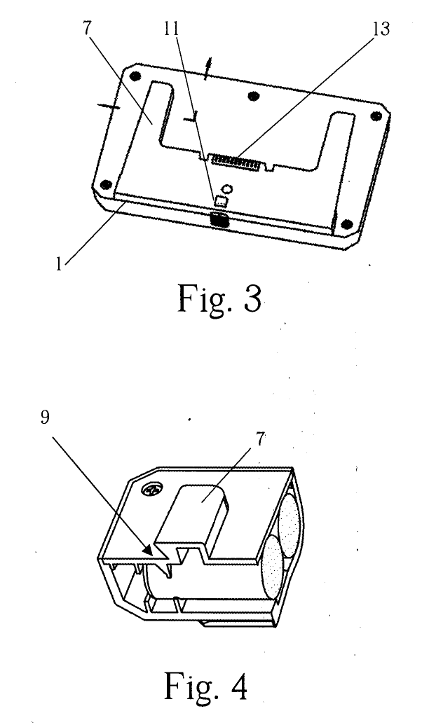

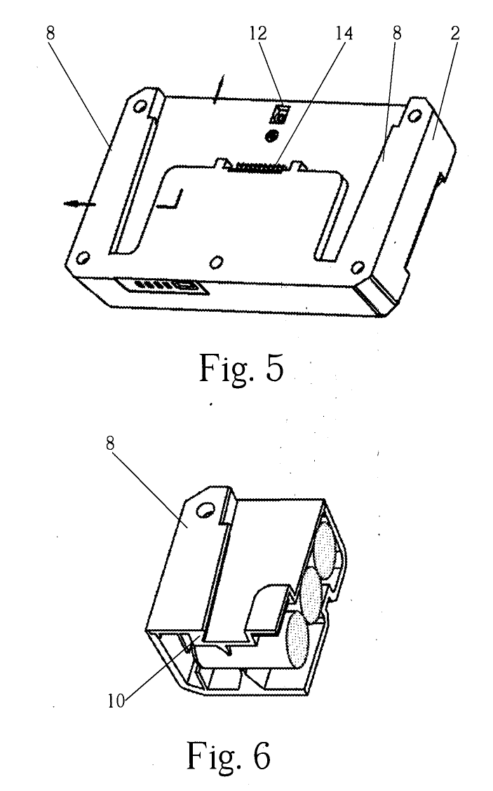

Refer to FIGS. 3, 4, 5 and 6 the physical connection between Boxes 1 and 2 can adopt various mechanical conjunction methods. The conjunction of the present embodiment is a kind of dovetail join structure including the dovetail 10 and the dovetail slot 9, which are matched each other and located in the convex pieces 8 and 7 respectively. The dovetail 10 of the box 2 is inserted into the dovetail slot 9 of box 1 to create face to face connection, and then the two boxes are locked by pin 11 and hole 12 to prevent relative movement. The pin 11 on the box 1 can be moved up and down, the hole 12 is on the box 2. The boxes 1 and 2 also have electric plug and socket 13 and 14.

The identification chip 3, alarm device 4, power switch 5 and identity mark chip 6 constitute an intelligence control system of the present invention. The system can judge whether the two battery boxes which be disassembled for transportation and put together for usage are matched for forming a couple, to guarantee of their consistent in capacity, voltage and usage time. The FIG. 7 shows the diagram of electricity principle and the FIG. 8 shows the electric circuit.

In addition, the identity mark chip shown on the FIG. 7 can be replaced by an electronics label, the identification chip 3 stores the global unique code of electronics label, i.e. ID code.

The alarm device of this embodiment uses sound (buzzer) or light (irradiance diode) alarms. When the boxes are connected on their position, the plug and socket 13 and 14 are connected to turn identity mark chip 6 and identification chip 3 on. The identification chip 3 reads the identity mark (factory wrote it in chip and it can not be changed too) in the identity mark chip automatically under the program control, and compares it with the identity mark stored in the identification chip. If consistent, then the identification chip 3 will not send out action signal to the triode transistor Q3 for the alarm device 4 and the triode transistor Q2 for the power switch 5. If not consistent, then the identification chip 3 will turn the triode transistors Q2 and Q3 on; the transistor Q2 as a power switch cuts off the power circuit to the power connectors and stop power supply; at the same time the Q2 turns the irradiance diode on, and issues alarm light; the Q3 is turned on to make the buzzer LS1 alarm, to notify the user that the two boxes are not coupled, can not operate normally, The boxes have to be replaced as a coupled pack for operating in order. If missing the triode transistor Q1 as power switch, the connected boxes can still provide power supply, but the alarm device is still working, reminds the user to replace the boxes for safety use and long usage life. Therefore, the embodiment should comprise the power switch in order to prevent damage batteries.

The connection between the boxes 1 and 2 can adopt other modes, it can be the bottom face with top face, which has bigger contacting area, or can be the side face with side face, which has smaller contacting area. The number of box can be adjusted according to the battery capacity, can be two or three or more. Anyhow, the large assembled lithium-ion battery pack with lithium equivalent over the safety bar can be disassembled into multiple boxes of lithium-ion batteries pack with a lithium equivalent under the safety bar, and these boxes of lithium batteries are connected together in serious or parallel, passed through the consistency examination by the identification cheap and identity mark cheap and sound or light alarm, this is the core of the present invention and the key content for patent protection.

What is claimed is:

1. An assembled lithium-ion battery pack with large capacity, Comprising:
at least two boxes which can be connected as a single unite or disassembled as multiple boxes;
each said box including multiple lithium-ion batteries connected in series or parallel, total lithium equivalent of said box is smaller than transportation safety bar;
the pack of connected lithium batteries in one of said boxes being connected with other pack of connected lithium batteries in other one of said boxes in series or parallel;
one of said boxes including an identification chip and alarm device controlled by said identification chip;
other one of said boxes including an identity mark chip; said identification chip storing the identity mark of said identity mark chip.

2. The assembled lithium-ion battery pack of claim 1, wherein the connection between said boxes is a dovetail join structure, the orientation and locking is a pin and a hole structure.

3. The assembled lithium-ion battery pack of claim 1, wherein said identity mark chip is an electronic label, said identification chip stores the content of said electronic label.

4. The assembled lithium-ion battery pack of claim 1, wherein said identification chip connects a power switch constituted by triode transistors Q1 and Q2.

5. The assembled lithium-ion battery pack of claim 1, wherein said alarm device is buzzer and/or irradiance diode.
